(19) United States
(12) Patent Application Publication
(10) Pub. No.: US 2003/0144901 A1
(43) Pub. Date: Jul. 31, 2003

(54) Managing supplier and alliance partner performance data

(76) Inventors: Jeffery R. Coulter, Frisco, TX (US); Terry E. Mullis, Frisco, TX (US); Nancy R. Meduna, Omaha, NE (US); Jeffrey B. Cotten, Addison, TX (US); Jason B. Fox, Plano, TX (US)

Correspondence Address: BAKER BOTTS L.L.P., 2001 ROSS AVENUE, SUITE 600, DALLAS, TX, 75201-2980, US

(21) Appl. No.: 10/254,822

(22) Filed: Sep. 24, 2002

Related U.S. Application Data
(60) Provisional application No. 60/351,962, filed on Jan. 25, 2002.

(51) Int. Cl. G06F 17/60

(52) U.S. Cl. 705/11

(57) ABSTRACT

Managing performance data includes receiving a record of an agreement between a first party and a second party, where the second party is either a supplier or an alliance partner. Performance data describing the second party is retrieved. An evaluation of the second party evaluated with respect to the agreement and the performance data is received. The record of the agreement, the performance data, and the evaluation of the second party are reported.

### RELATED APPLICATIONS

This application claims benefit under 35 U.S.C. § 119(e) of U.S. Provisional Application Serial No. 60/351,962, filed Jan. 25, 2002, entitled “MANAGING SUPPLIER AND ALLIANCE PERFORMANCE DATA.”

### TECHNICAL FIELD OF THE INVENTION

This invention relates generally to the field of performance data systems and more specifically to managing supplier and alliance partner performance data.

### BACKGROUND OF THE INVENTION

Organizations such as corporations use suppliers to obtain supplies for generating their products and services. In addition, organizations leverage relationships with alliance partners to jointly market and deliver the products and services. Although there exist performance data systems that monitor client relationships, little attention has been paid to monitoring supplier and alliance partner relationships. Consequently, managing supplier and alliance partner performance data has posed challenges.

### SUMMARY OF THE INVENTION

According to one embodiment of the present invention, managing performance data includes receiving a record of an agreement between a first party and a second party, where the second party is either a supplier or an alliance partner. Performance data describing the second party is retrieved. An evaluation of the second party evaluated with respect to the agreement and the performance data is received. The record of the agreement, the performance data, and the evaluation of the second party are reported.

Certain embodiments of the invention may provide technical advantages. A technical advantage of one embodiment may include a dashboard that an organization may use to manage and measure the effectiveness of supplier and alliance relationships. The organization may, for example, reduce its expenses by eliminating redundant agreements with suppliers, and increase its productivity by building strategic relationships with more effective alliance partners. The benefits to the organization may include reduced procurement costs, increased ability to leverage supplier relationships, improved management and measurement of alliance performance, and exposure of supplier products to the organization's capabilities and service offerings.

Certain embodiments of the invention may include none, some, or all of the technical advantages. Other technical advantages are readily apparent to one skilled in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 is a block diagram illustrating one embodiment of a system for managing supplier and alliance partner performance data;

FIG. 2 is flowchart illustrating one embodiment of a method for managing supplier and alliance partner data;

FIG. 3 is a block diagram illustrating the supplier/alliance database of FIG. 1;

FIG. 4 illustrates one embodiment of an architecture for components;

FIG. 5 illustrates embodiments of security strings that may be utilized by the security component of FIG. 4;

FIG. 6 illustrates examples of site maps for screens that may be used to report alliance partner information;

FIG. 7 illustrates an example of a view alliance summary screen of FIG. 6;

FIG. 8 illustrates an example of a view alliance agreement detail screen of FIG. 6;

FIG. 9 illustrates an example of an alliance event detail screen of FIG. 6;

FIG. 10 illustrates examples of site maps for screens that may be used to report supplier information to a user; and

FIG. 11 illustrates an example of a view supplier summary screen of FIG. 10.

### DETAILED DESCRIPTION OF THE DRAWINGS

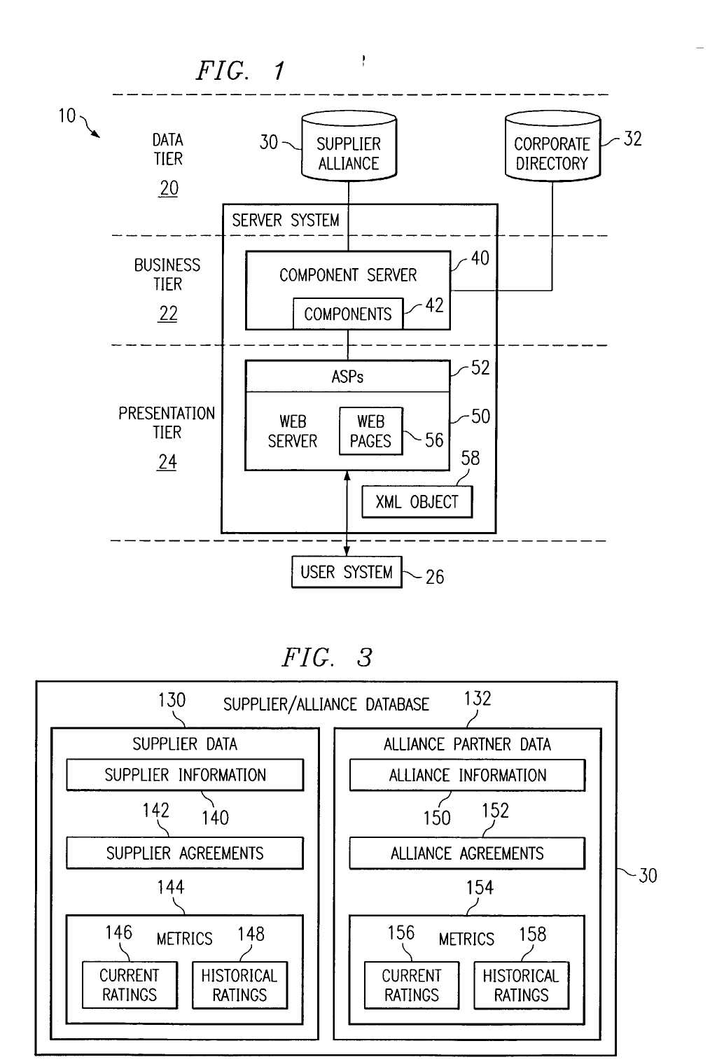

Embodiments of the present invention and its advantages are best understood by referring to FIGS. 1 through 11.

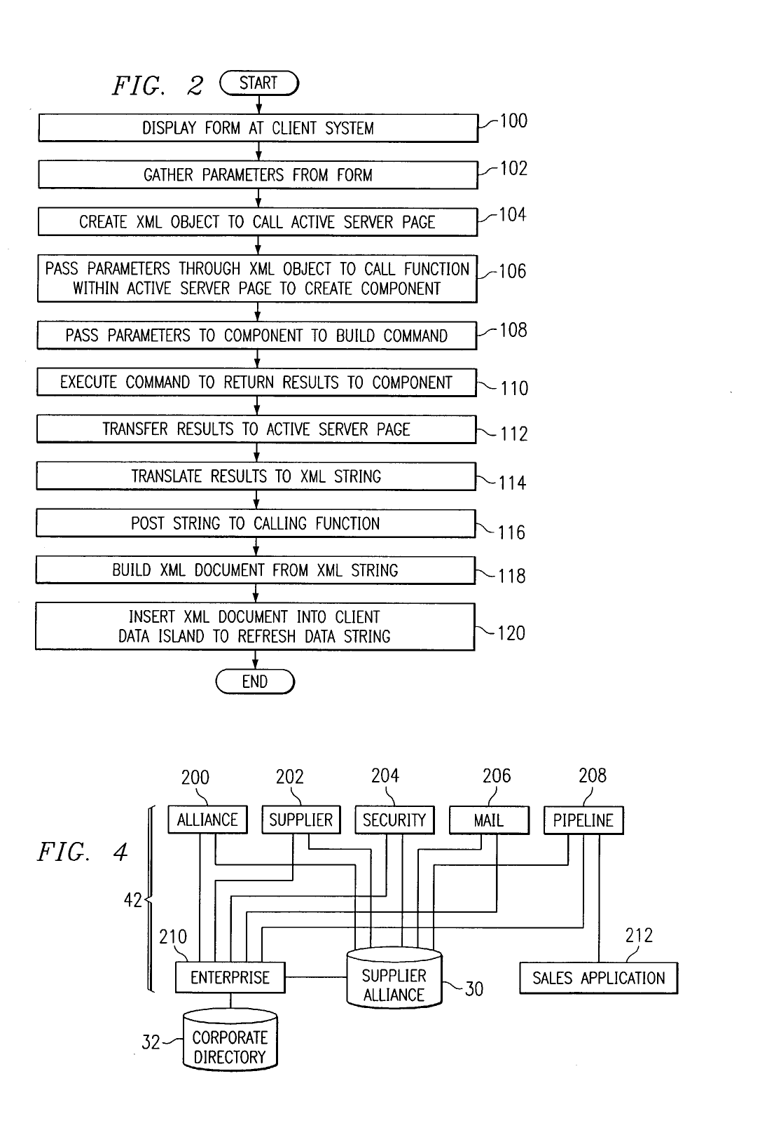

FIG. 1 illustrates one embodiment of a system 10 for managing supplier and alliance partner performance data. System 10 processes and reports data describing the performance of suppliers and alliance partners of an organization. System 10 may report, for example, commitments made by a supplier or alliance partner and performance data for the supplier or alliance partner, so that the performance data may be evaluated with respect to the commitments. One embodiment of a method for managing performance data using system 10 is described in more detail with reference to FIG. 2.

According to one embodiment, system 10 comprises three tiers: a data tier 20, a business tier 22, and a presentation tier 24. Data tier 20 handles data storage, business tier 22 involves business logic, and presentation tier 24 handles interaction between system 10 and a user system 26.

Data tier 20 is responsible for data access and is used by business tier 22 to manipulate data. Data tier 20 may comprise a supplier/alliance database 30 and a corporate directory 32. Supplier/alliance database 30 and corporate directory 32 may comprise, for example, an structured query language (SQL) server database. Supplier/alliance database 30 stores data that describes commitments and performance of suppliers and alliance partners of an organization. The data may include an agreement between a supplier or alliance partner and the organization, and metrics that are used to evaluate whether the supplier or alliance partner is satisfying the agreement. Supplier/alliance database 30 is described in more detail with respect to FIG. 3. Corporate directory 32 may comprise a Lightweight Directory Access Protocol (LDAP) directory server, which is used to authenticate users of an organization.

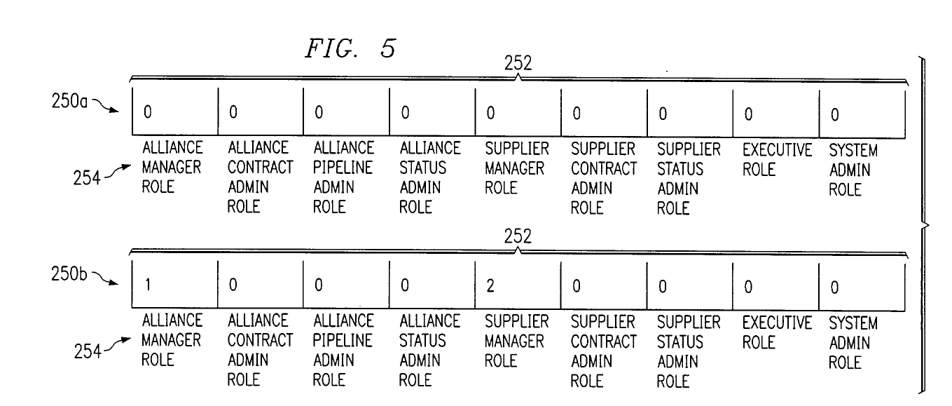

Business tier 22 includes a component server 40 that houses components 42 that encapsulate business logic that provides business rules and processing. Components 42 comprise server side components that receive input from presentation tier 24, and use data tier 24 to access data to generate output. Component server 40 may comprise a Microsoft Transaction Server (MTS), and components 42 may comprise Visual Basic Component Object Model (COM) Business objects. Examples of components 42 are described in more detail with reference to FIGS. 4 and 5.

Presentation tier 24 includes a web server 50 and active server pages (ASPs) 52. Web server 50 includes a set of web pages 54 through which user system 26 interacts with system 10. Web server 50 may comprise an Internet Information Server (IIS). Active server pages 52 include text, hypertext markup language (HTML), and commands that may be performed by web server 30. User system 26 may call an active server page 52 using an extensible markup language (XML) object 56.

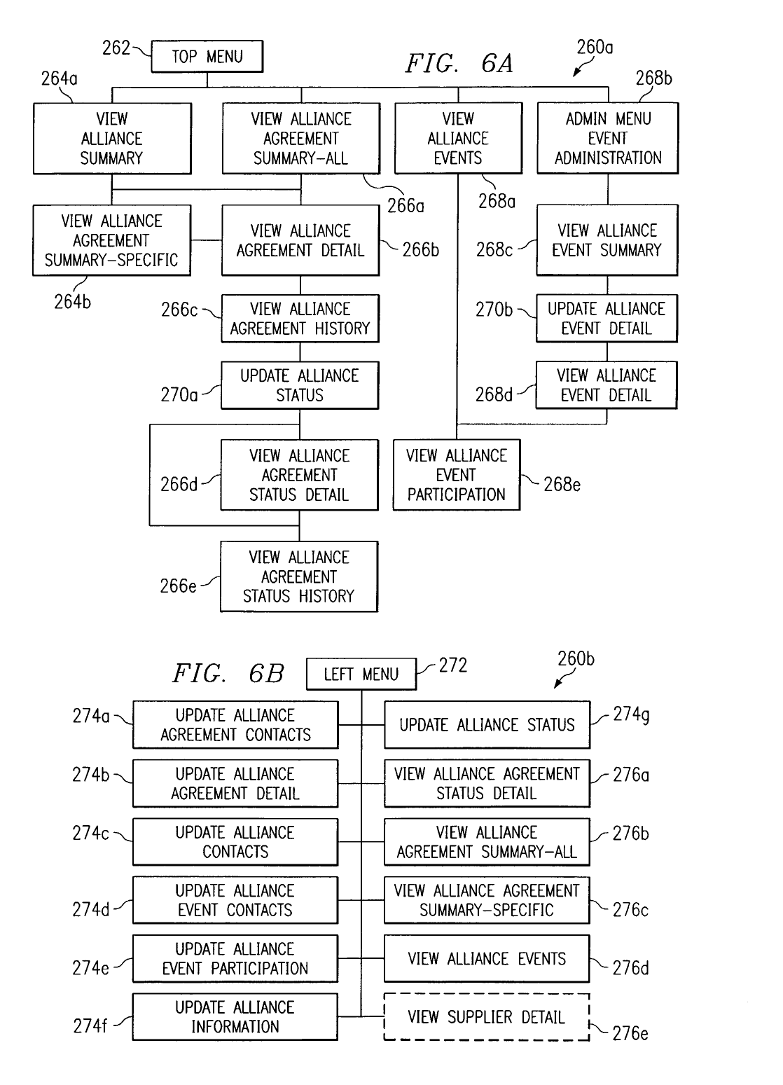

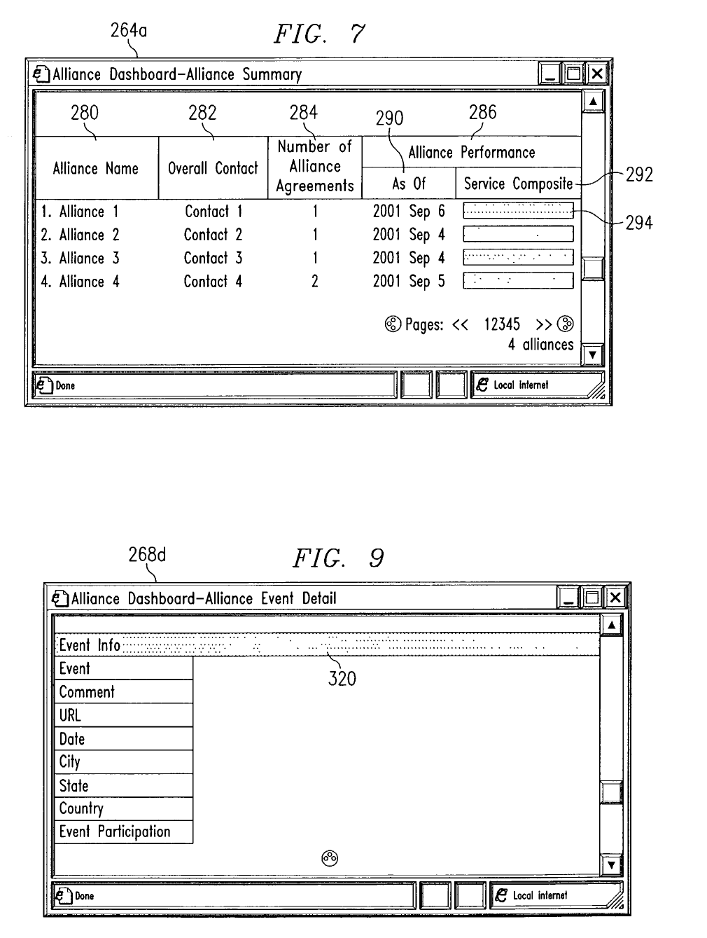

Web pages 56 may present performance data through a dashboard. The dashboard may present supplier and alliance partner data at a high level aggregate view to enable users to discern a large amount of information in a summarized fashion. In addition, the dashboard may display the information in a graphical format. Examples of dashboard screens are described with reference to FIGS. 6 through 11.

System 10 allows an organization to manage suppliers and alliance partners more effectively and efficiently. The organization may be able to track the performance of suppliers and alliance partners through various metrics. With the dashboard, the organization may be able to answer questions such as: What are we buying from a supplier, and how much are we spending? How well is this supplier/alliance partner meeting the commitments? How are our supplier/alliance partner practices changing over time?

FIG. 2 is flowchart illustrating one embodiment of a method for managing supplier and alliance partner data. According to the embodiment, user system 26 requests information about a person from system 10. A web page 56 for a data request form is displayed for user system 26 at step 100.

Parameters defining the request are input into the data request form. The parameters may include, for example, a person's name. The parameters are gathered for the data request form by user system 26 at step 102. An XML object 58 that is used to call an active server page 52 is created step 104. The parameters are passed through XML object 58 to call a function within active server page 50 to create a component 42 at step 106. The same parameters are passed to component 42 at step 108 to build a command with the parameters to execute a stored procedure. The command is executed at step 110 to return results to component 42. Results may comprise, for example, data associated with the requested name.

The results are transferred to active server page 50 at step 112. Active server page 50 translates the results into an XML string at step 114, and posts the XML string back to the calling function at step 116. Web server 52 builds an XML document from the XML string at step 118. The XML document is inserted into a data island within web page 56 at step 120 to refresh the data island with the XML string. After refreshing the data island, the method terminates.

FIG. 3 is a block diagram illustrating supplier/alliance database 30 of FIG. 1. Supplier/alliance database 30 stores supplier data 130 alliance partner data 132.

Supplier data 130 comprises information about suppliers that provide supplies such as products or services to an organization. Supplier data 130 includes supplier information 140, supplier agreements 142, and metrics 144. Supplier information 140 may include, for example, the company name and address and contact information for contact people. According to one embodiment, a unique identifier for supplier information 140 comprises a vendor code.

Supplier agreements 142 includes a contract between a supplier and the organization that describe commitments that the supplier has made to the organization. Commitments may include, for example, a quantity of supplies to be delivered to the organization by a due date. Metrics 144 are used to determine whether the performance of the supplier is satisfying the commitments of the supplier. A metric 144 may comprise, for example, on-time delivery. The performance is evaluated with respect to a commitment to generate a metric rating for each metric. For example, a supplier with an 80 percent on-time delivery performance is evaluated with respect to a commitment of 95 percent on-time delivery to yield a metric rating of poor for an on-time delivery metric. System 10 provides data used to determine the performance, including, for example, spending information and historical information. Metrics 144 may be evaluated by managers of the organization. Organization managers compare the supplier performance with supplier agreements 142 to evaluate the metrics 144 to provide metric ratings.

Current ratings 146 comprise metric ratings for the current period, and historical ratings 148 comprise metric ratings from previous periods. Historical ratings 148 may be used to determine trends in performance. Periodically, the evaluations of current ratings 146 are transferred to historical ratings 148. If a metric evaluation was not updated during a period, the evaluation may be reported as not available during that period.

According to one embodiment, metrics 144 for suppliers may include, for example:

1. The Service Excellence metric measures the supplier's overall service provided to the organization. The supplier's responsiveness to problem resolution is a primary factor for this metric. Responsiveness may involve communication, problem resolution, responsiveness, and flexibility.

2. The Support metric measures the supplier's efforts in sales/marketing and production support. Sales and marketing support may include the ability to work within the organization's business processes, ability to provide knowledgeable subject matter experts, and responsiveness. Production support may include the ability to meet service level agreements and responsiveness to problems.

3. The Technology metric measures the ability of the supplier's products/services to meet the organization's demand. Assessing the ability involves considering the supplier's rank within the industry, technical competency, ability to meet the organization's technology direction, and ability to meet the organization's client's needs.

4. The Cost/Contracting metric measures the supplier's cost and contracting power with respect to the benefits the supplier brings to the organization. Cost may involve price, ability to provide global prices, price flexibility, and return on investment. Contracting power may involve information about contract discussions, present contract terms and conditions, and performance against contract.

5. The Global Presence metric measures the supplier's ability to conduct business on a global scale. The ability may involve sales support, service, training, and pricing.

Alliance partner data 132 comprises information about alliance partners that have alliance agreements with an organization. Alliance partner data 132 includes company information 150, alliance agreements 152, and metrics 154. Company information 150 may include, for example, the company name and address and contact information for contact people. An alliance agreement 152 includes agreements between an alliance partner and the organization that describes commitments that the alliance partner has made to the organization. Commitments may include, for example, a quantity of products to be sold by the alliance partner by a due date. Metrics 154 are used to determine whether the performance of the alliance partner is satisfying the commitment of the alliance partner. A metric 154 may comprise, for example, products sold. Performance is evaluated with respect to a commitment to generate a metric rating for each metric. For example, an alliance partner that has sold only 80 percent of products that it promised to sell has a metric rating of poor.

Metrics 154 for alliance partners may include, for example:

1. The Financial Performance metric measures overall performance with respect to commitments. This metric may involve the achievement of total contract value, variance between actual and forecasted expenses, and return on investment.

2. The Sales and Marketing Relationship metric may involve considering the number of trade shows attended, press mentions generated, and leads and signed deals created by the alliance partner.

3. The Training and Documentation metric may involve the number of personnel trained and completion of proposed documentation.

4. The Technology Relationship metric may involve on-time product/service development and delivery.

5. The General Relationship metric may measure the overall relationship with respect to, for example, the achievement of targets, number of trained resources, marketing/sales/delivery commitments, and level of communication. The metric may include assessing the dedicated resources, executive support, issue resolution, delivery, and contractual performance.

6. The Partner Relationship metric measures the relationship the alliance partners have with the organization. The metric may involve assessing communications, cross organizational cooperation, financial status, management stability, effective issue resolution, accounts receivable, and client satisfaction associated with the alliance partner.

Metrics 144 and 154 provide the ability to identify better suppliers and alliance partners, and build more strategic and profitable relationships with suppliers and alliance partners. By rating suppliers and alliance partners, an organization may identify top-performing suppliers and alliance partners. In addition, by measuring a supplier's or alliance partner's performance over time, the organization may be able to better negotiate more strategic agreements. This may enable the organization to more efficiently and effectively support clients.

FIG. 4 illustrates one embodiment of an architecture for components 42. Components 42 may run within Component Object Model+(COM+), may be written in Visual Basic 6.0, and may be compiled into a dynamic link library (DLL) to be accessed as a COM object. The interfaces of components 42 may have multiple ASP pages as well as batch processing to perform their functions.

Components 42 may include, for example, an alliance component 200, a supplier component 202, a security component 204, a mail component 206, a pipeline component 208, and an enterprise component 210. Alliance component 200 accesses supplier/alliance database 30 and corporate directory 32 for data describing alliances. Alliance component 200 may view, update, add, and delete alliance information 150 of supplier/alliance database 30, and may access corporate directory 32 to retrieve information for supplier/alliance database 30. Similarly, supplier component 202 accesses supplier/alliance database 30 and corporate directory 32 for data describing suppliers. Alliance component 202 may view, update, add, and delete supplier information 140 of supplier/alliance database 30, and may access corporate directory 32 to retrieve information for supplier/alliance database 30.

Security component 204 accesses supplier/alliance database 30 and corporate directory 32 to perform security functions. Security component 204 may view, update, add, and delete security information of supplier/alliance database 30, and may access corporate directory 32 to retrieve information for supplier/alliance database 30. Data may be transmitted using secure socket layers over an open network architecture such as the Internet's Terminal Control Protocol-Internet Protocol (TCP-IP). Databases may reside in secure locations inside a local area network (LAN) behind a firewall providing added security for databases 30 and 32. Mail component 206 manages mail functions.

Pipeline component 208 accesses data about alliance partners that have pipeline opportunities retrieved from a sales application 212, for example, the S-FORCE software by EDS CORPORATION. Procedures stored in pipeline component 208 may be used to associate alliance partners documented in alliance partner data 132 and alliance partners having pipeline opportunities according to sales application 212.

Enterprise component 210 allows other components 200-208 access to corporate directory 32. For example, enterprise component 210 may provide supplier component 202 access to corporate directory 32 to obtain current data for supplier information such as contact name, phone number, email address, and organization that may be used to update supplier information 140. Corporate directory 32 may be accessed using a Lightweight Directory Access Protocol (LDAP).

FIG. 5 illustrates embodiments of security strings 250a-b that may be utilized by security component 204 of FIG. 4. Security component 204 may use role-based access control. Role-based access control grants a level of access to a user based on a role assigned to the user. The roles may based on business roles such as administrator or executive, and the levels may be based on the type of system manipulation such as view or update.

Each user has a security string 250a-b that describes the roles and access levels assigned to the user. A security string comprises a string of characters 252. Each character 252 or set of characters 252 is associated with a possible role 254. The character 252 or set of characters 252 identifies the level of access granted for that particular role 254. As an example, a character 252 may comprise a number that indicates the level of access as follows:

0—Role does not exist for this user;

1—View capabilities are granted to a user for the respective role; and

2—View and update capabilities are granted to a user for the respective role.

Security string 250a has zeros for roles 254, which means that the user associated with security string 250a is a general user and can only access information that is available to the general organizational public. The user associated with security string 250b has an alliance manager role, but can only view data that is available to alliance managers. The user also has a supplier manager role and can view and update data that is available to supplier managers.

FIG. 6 illustrates examples of site maps 260a-d for screens that may be used to report alliance partner information. Site map 260a describes a top menu 262 that may be placed along the top of a screen. Top menu 262 allows for access to screens 264a-b that may be used to view alliance and alliance agreement summary information. For example, a view alliance summary screen 264a provides summary information for alliance partners. View alliance summary 264a is described in more detail with reference to FIG. 7.

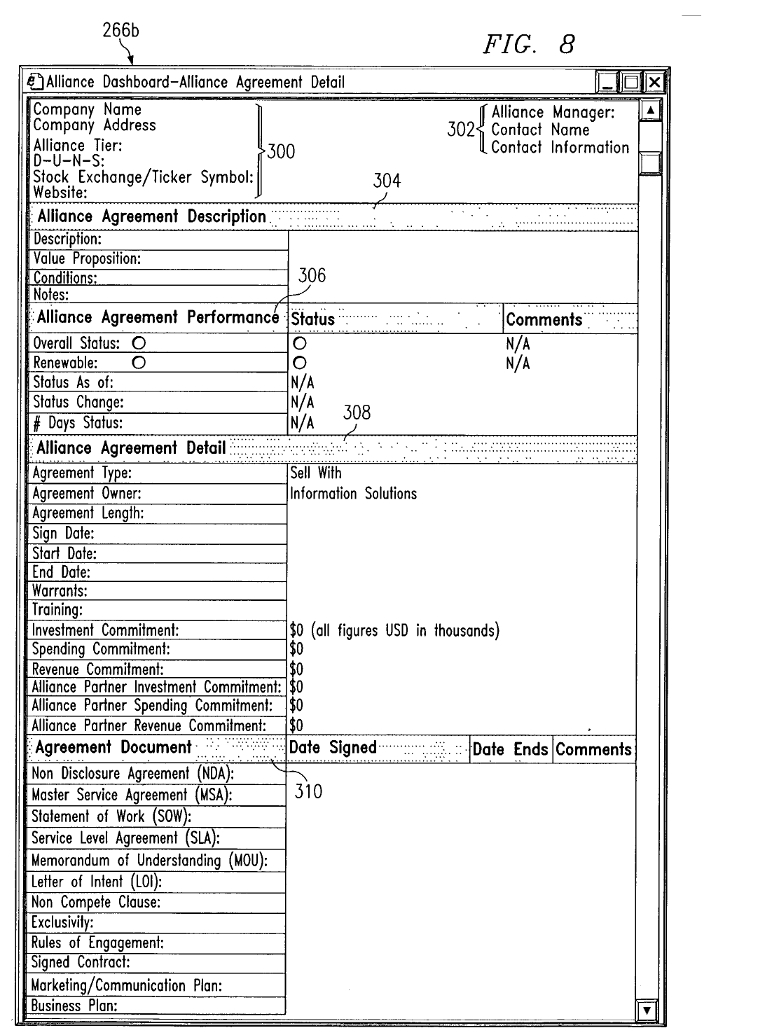

Screens 266a-e provide additional information about alliance agreements. The additional information may include a summary of the alliance agreements, details about an alliance agreement, the history of an alliance agreement, the status of an alliance agreement, and the history of the status of an alliance agreement. For example, a view alliance agreement detail screen 266b provides detailed information about a specific alliance agreement. View alliance agreement detail 266b is described in more detail with reference to FIG. 8.

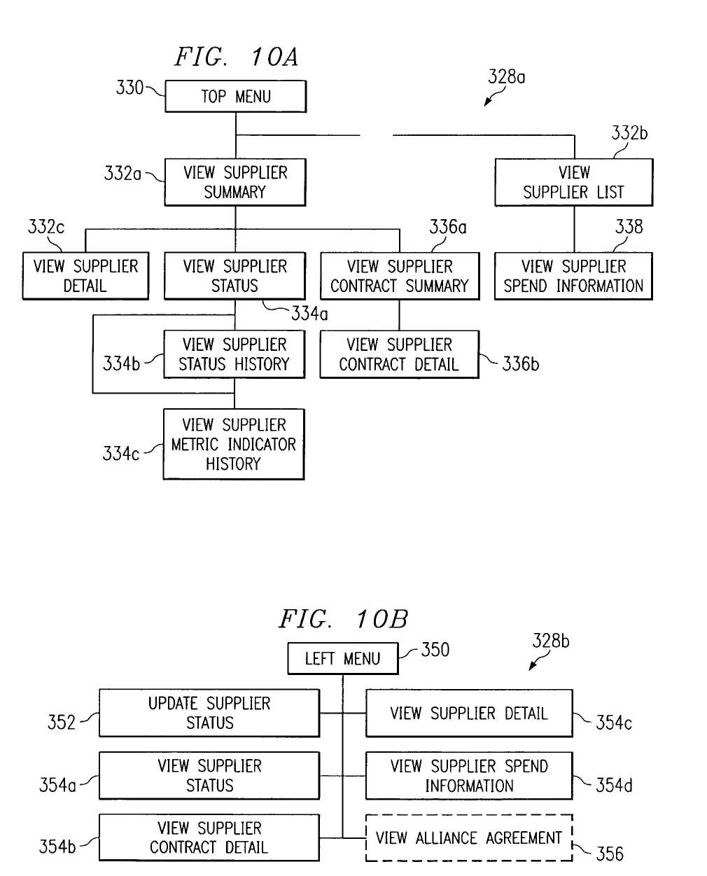

Screens 268a-e may be used to view information about alliance events. Screens 268a-e may provide information about event administration, a summary of the alliance events, details about a particular event, and event participation. For example, a view alliance event detail screen 268d provides detailed information about a specific alliance event. View alliance event detail 268d is described in more detail with reference to FIG. 9. Screens 270a-d may be used to update the status of an alliance partner or to update the details of an alliance event.

Site map 260b describes a left menu 272 that may be placed along the side of a screen. Screens 274a-g may be used to update information such as alliance agreement contacts, alliance agreement details, alliance contacts, and event contacts. Screens 274a-g may also be used to update alliance event participation, alliance information, and alliance status. Screens 276a-e may be used to view alliance information. For example, screens 276a-e may be used to view the status of alliance agreements, a summary of all the alliance agreements, a specific summary of the alliance agreements, alliance events, and supplier detail.

FIG. 7 illustrates an example of a view alliance summary screen 264a of FIG. 6. View alliance summary screen 264a includes an alliance name column 280, an overall contact column 282, a number of alliance agreements column 284, and an alliance performance column 286. Alliance name column 280 lists the names of the alliance partners. Overall contact column 282 lists the names of the contact people for the alliance partners. Number of alliance agreements column 284 lists the number of alliance agreements that the alliance partner has with the organization.

Alliance performance column 286 includes an as of column 290 and a service composite column 292. As of column 290 reports the date of the most recent alliance performance evaluation. Service composite column 292 displays metric composites 294 that describe the latest evaluation of the metrics. Composite bar 294 may be used in indicate the proportion of metrics that have specific ratings. For example, a composite bar 294 may include a red portion, a yellow portion, and a green portion. The red portion of composite bar 294 may represent the proportion of metrics that have a poor rating, the yellow portion may represent the proportion of metrics that have an average rating, and a green portion may represent the proportion of metrics that have a good rating.

FIG. 8 illustrates an example of a view alliance agreement detail screen 266b of FIG. 6. View alliance agreement detail screen 266b includes company information 300 and alliance manager information 302. Company information 300 may include information about the alliance partner such as the name, address, alliance tier information reference, D-U-N-S identifier, stock exchange/ticker symbol, and web site address. Alliance manager information 302 may include a contact name and contact information for the alliance manager.

View alliance agreement detail screen 266b may also include an alliance agreement description section 304, an alliance agreement performance section 306, an alliance agreement detail action 308, and an agreement document section 310. Alliance agreement description section 304 includes a description of the alliance agreement, a value proposition of the alliance agreement, conditions, and notes. Alliance agreement performance section 306 includes status and comments for the overall status of the alliance performance and for the renewability of the alliance agreement. The date of the last status entry, any change in status, and the number of days of the current status are also provided.

Alliance agreement detail section 308 includes information about the type of agreement, the owner of the agreement, and the term of the agreement. The dates of signing, starting, and ending the agreement are also provided. Warrants and training conditions are listed. Commitments for the organization's investment, spending, and revenue are also presented. Commitments for the alliance partner's investment, spending, and revenue are also presented.

Agreement document section 10 lists dates of signing and ending and comments for documents associated with the alliance agreement. Documents may include, for example, a non-disclosure agreement, a master service agreement, a statement of work, a service level agreement, a memorandum of understanding, a letter of intent, a non-compete clause, an exclusivity agreement, a rules of engagement agreement, a signed contract, a marketing/communication plan, and a business plan.

FIG. 9 illustrates an example of an alliance event detail screen 268d of FIG. 6. View alliance event details screen 268d includes event information 320 such as the name of the event, comments about the event, and a URL for the event. The date, city, state, and country of the event are also provided. Event participants are also displayed.

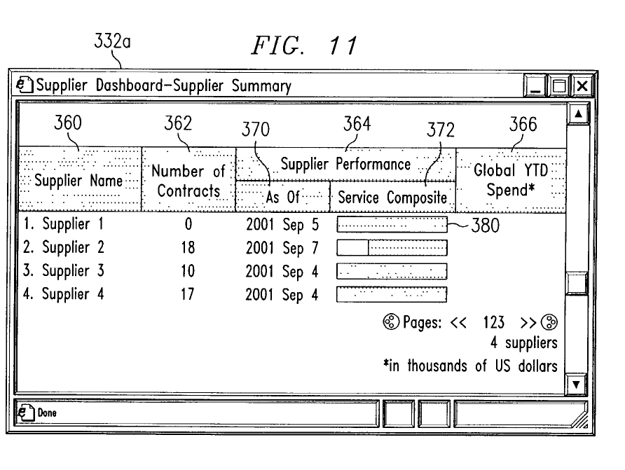

FIG. 10 illustrates examples of site maps 328a-b for screens that may be used to report supplier information to a user. Site map 328a describes a top menu 330 that may be displayed across the top of a screen. Top menu 330 includes screens 332a-c that may be used to view supplier information such as a summary or list of the suppliers or the details about a particular supplier. For example, a view supplier summary screen 332a provides a summary of the suppliers. View supplier summary screen 332a is described in more detail with reference to FIG. 11.

Screen 334a-c may be used to view the status of the suppliers. Screens 334a-c may provide information on the status of a supplier, the history of the status, and a history of metric indicators for the supplier. Screens 336a-b may be used to view information about supplier contracts. Screens 336a-b may provide a summary of the supplier contracts or the details of a specific supplier contract. A screen 338 may be used to view the spending information for suppliers.

A site map 328b describes a left menu 350 that may be displayed on the side of a screen. A screen 352 may be used to update the status of a supplier. Screens 354a-d may be used to view supplier information such as the status of a supplier, the details of a supplier contract, the details of a supplier, and the spending information for a supplier. A screen 356 may be used to view alliance agreements.

FIG. 11 illustrates an example of a view supplier summary screen 332a of FIG. 10. View supplier summary screen 332a includes a supplier name column 360, a number of contracts column 362, a supplier performance column 364, and a global year-to-date spend column 366. Supplier name column 360 lists the names of the suppliers. Number of contracts column 362 identifies the number of contracts for each supplier. Supplier performance column 364 includes an as of column 370 and a surface composite column 372. As of column 370 provides the date of the latest supplier performance evaluation. Service composite column 372 displays a composite bar 380 that describes the ratings for the supplier metrics. Global year-to-date spend column 366 provides year-to-date spending information for each supplier.

The screens described in FIGS. 6 through 11 may be modified or formatted differently without departing from the scope of the invention. Additionally, some screens may be omitted, and other screens may be used. For example, screens may be used to show supplier spending data categorized by region.

Certain embodiments of the invention may provide technical advantages. A technical advantage of one embodiment may include a dashboard that an organization may use to manage and measure the effectiveness of supplier and alliance relationships. The organization may, for example, reduce its expenses by eliminating redundant agreements with suppliers, and increase its productivity by building strategic relationships with more effective alliance partners. The benefits to the organization may include reduced procurement costs, increased ability to leverage supplier relationships, improved management and measurement of alliance performance, and exposure of supplier products to the organization's capabilities and service offerings.

Although an embodiment of the invention and its advantages are described in detail, a person skilled in the art could make various alterations, additions, and omissions without departing from the spirit and scope of the present invention as defined by the appended claims.

What is claimed is:

1. A method for managing performance data, comprising:
receiving a record of an agreement between a first party and a second party, the second party comprising a member selected from a group consisting of a supplier and an alliance partner;
retrieving performance data describing the second party;
receiving an evaluation of the second party evaluated with respect to the agreement and the performance data; and
reporting the record of the agreement, the performance data, and the evaluation of the second party.

2. The method of claim 1, wherein the second party comprises the supplier agreeing to provide a supply to the first party.

3. The method of claim 1, wherein the second party comprises the alliance partner agreeing to increase a revenue associated with the first party.

4. The method of claim 1, further comprising:
receiving a security string associated with a user, the security string comprising a plurality of roles, each role associated with a value, the value corresponding to a level of access; and
granting the user access in accordance with the security string.

5. The method of claim 1, further comprising:
receiving spending data associated with the second party;
receiving the evaluation of the second party evaluated with respect to the spending data; and
reporting the spending data.

6. The method of claim 1, further comprising:
receiving event data associated with the second party;
receiving the evaluation of the second party evaluated with respect to the event data; and
reporting the event data.

7. A system for managing performance data, comprising:
a database operable to store data; and
a server system coupled to the database and operable to:
receive a record of an agreement between a first party and a second party, the second party comprising a member selected from a group consisting of a supplier and an alliance partner;
retrieve performance data describing the second party;
receive an evaluation of the second party evaluated with respect to the agreement and the performance data; and
report the record of the agreement, the performance data, and the evaluation of the second party.

8. The system of claim 7, wherein the second party comprises the supplier agreeing to provide a supply to the first party.

9. The system of claim 7, wherein the second party comprises the alliance partner agreeing to increase a revenue associated with the first party.

10. The system of claim 7, the server system further operable to:
receive a security string associated with a user, the security string comprising a plurality of roles, each role associated with a value, the value corresponding to a level of access; and
grant the user access in accordance with the security string.

11. The system of claim 7, the server system further operable to:
receive spending data associated with the second party;
receive the evaluation of the second party evaluated with respect to the spending data; and
report the spending data.

12. The system of claim 7, the server system further operable to:
receive event data associated with the second party;
receive the evaluation of the second party evaluated with respect to the event data; and
report the event data.

13. A software for managing performance data, the software embodied in a medium and operable to:
receive a record of an agreement between a first party and a second party, the second party comprising a member selected from a group consisting of a supplier and an alliance partner;
retrieve performance data describing the second party;
receive an evaluation of the second party evaluated with respect to the agreement and the performance data; and
report the record of the agreement, the performance data, and the evaluation of the second party.

14. The software of claim 13, wherein the second party comprises the supplier agreeing to provide a supply to the first party.

15. The software of claim 13, wherein the second party comprises the alliance partner agreeing to increase a revenue associated with the first party.

16. The software of claim 13, further operable to:
receive a security string associated with a user, the security string comprising a plurality of roles, each role associated with a value, the value corresponding to a level of access; and
grant the user access in accordance with the security string.

17. The software of claim 13, further operable to:
receive spending data associated with the second party;
receive the evaluation of the second party evaluated with respect to the spending data; and
report the spending data.

18. The software of claim 13, further operable to:
receive event data associated with the second party;
receive the evaluation of the second party evaluated with respect to the event data; and
report the event data.

19. A system for managing performance data, comprising:
means for receiving a record of an agreement between a first party and a second party, the second party comprising a member selected from a group consisting of a supplier and an alliance partner;
means for retrieving performance data describing the second party;
means for receiving an evaluation of the second party evaluated with respect to the agreement and the performance data; and
means for reporting the record of the agreement, the performance data, and the evaluation of the second party.

20. A system for managing performance data, comprising:
a database operable to store data; and
a server system coupled to the database and operable to:
receive a record of an agreement between a first party and a second party, the second party comprising a member selected from a group consisting of a supplier and an alliance partner, the supplier agreeing to provide a supply to the first party, the alliance partner agreeing to increase a revenue associated with the first party;
retrieve performance data describing the second party, receive an evaluation of the second party evaluated with respect to the agreement and the performance data, and report the record of the agreement, the performance data, and the evaluation of the second party;
receive a security string associated with a user, the security string comprising a plurality of roles, each role associated with a value, the value corresponding to a level of access, and grant the user access in accordance with the security string;
receive spending data associated with the second party, receive the evaluation of the second party evaluated with respect to the spending data, and report the spending data; and
receive event data associated with the second party, receive the evaluation of the second party evaluated with respect to the event data, and report the event data.
